(19) United States
(12) Patent Application Publication
(10) Pub. No.: US 2017/0011629 A1
(43) Pub. Date: Jan. 12, 2017

(54) Public transit vehicle route schedule and notification system

(71) Applicant: CHUN NGOK LAU, HONG KONG (HK)

(72) Inventor: CHUN NGOK LAU, HONG KONG (HK)

(21) Appl. No.: 14/510,184

(22) Filed: Oct. 9, 2014

(51) Int. Cl. G08G 1/127; G08G 1/01

(52) U.S. Cl. CPC G08G 1/127; G08G 1/0133

(57) ABSTRACT

In an embodiment, a route schedule and notification system which includes a computer-implemented method in a mobile computing device is for collecting route context from a plurality of passengers along a roadway, transmitting the route context to a route context analytics server, providing an estimation of vehicle arrived to a target vehicle stop, generating an estimated arrival time notification for passenger to plan the schedule to wait for a vehicle arrival. Also, an embodiment, a route schedule and notification system which includes a computer-implemented method in the route context analytics server is for analysing, predicting or estimating the vehicle arrival and departure time, calculating the travel time of vehicle on the road, determining an alternative route to reach the destination, generating the real arrival time notification for passenger to plan the schedule to wait for a vehicle arrival.

### FIELD

The following disclosures generally describes providing an estimated vehicle arrival time on pick-up vehicle stop locally on mobile computing device, estimated vehicle real arrival or departure time on vehicle stops and generate notification from remotely by route context analytics server.

### BACKGROUND

Modern public transportation system assigns the transit vehicles (includes bus, minibus, streetcar, tram, trains, bus rapid transit, trackless trolley, shutter bus, school bus, coach etc.) route number or route identification to each route and vehicle stop name in every stops. Passengers wait for a vehicle approaching to the vehicle stop along roadway. Public transportation system only provided the simple and inaccurate route schedule or time table for passenger reference. The actual route schedule or time table is rapidly changing due to the unstable road traffic, special event, weather etc.

Public transportation system does not provide any record on vehicle arrival and departure time to each vehicle stop of the route. Passengers does not have any concrete and accurate data to help to determine the suitable time to wait for vehicle arrived in the pick-up vehicle stop or decide to change to another route in case of the vehicle is already left the pick-up vehicle stop. Passengers should wait for the vehicle without any useful information and support. There is lack of interaction and real time information sharing between the public transportation system and the passengers.

### SUMMARY

In an embodiment, a route schedule and notification system which includes a computer-implemented method in a mobile computing device is for collecting and saving a route context from a plurality of passengers at a pick-up vehicle stop along a roadway, providing an estimated time of vehicle approaching to a pick-up vehicle stop, providing a historical route context analysis and review, predicting the next available time range of the vehicle arrive to the vehicle stop, generating a notification for passenger to remind them plan the schedule to wait for vehicle arrival, transmitting the route context to a route context analytics server to perform a real time route analysis and provide an alternative route suggestion. The mobile computing device can be any kind of a variety of mobile device, such as smart phone, 2G, 3G, 4G LTE phone, application phone, personal digital assistant (PDA), tablet computer, notebook computer, mobile phone, cellular phone and any other known or later developed mobile device with cellular network, voice calls, SMS, EMS or MMS messaging and cellular data communication function.

The route context may be represented by a numeric or alphanumeric value may include a vehicle arrival time, get on vehicle stop name, vehicle route number or the route final stop name or station name, vehicle driver name, vehicle driver identification number, vehicle route identifier, vehicle license plate number, passenger waiting time at vehicle stop, every arrival time at different vehicle stop, get off vehicle time; may extra includes a schedule alert time range, route configuration, location mapping information, passenger preferences, passenger behavior from client application to remote server.

In an embodiment, a route schedule and notification system which includes a computer-implemented method in a route context analytics server is for receiving a route context from a plurality of mobile computing devices along a roadway, analysing, predicting or estimating the time of vehicle approaching to the vehicle stop, providing real vehicle departure time, calculating the travel time of vehicle on the road, determining an alternative vehicle route to reach the destination, generating the real time route notification for passenger to plan the schedule to wait for a vehicle arrival.

The route context may be represented by a numeric or alphanumeric value may include an alternative route suggestion, estimated arrival time, real departure time, next available vehicle arrival time, travel time of vehicle on the road.

The route context analytics server receiving and collecting the time of vehicle arrived at different vehicle stop per a single route from a plurality of passengers at pick-up vehicle stop, performing the vehicle route analysis, generating the arrival and departure time notification. The notification includes predicting on the vehicle arrival time due to the past record, providing the real vehicle arrival due to calculate the travel time from other route with same distance, providing departure time due to the vehicle left the prior vehicle stop, estimating the next vehicle arrival time based on the historical route record and the travel time, providing the alternative vehicle route close to the target vehicle stop.

### BRIEF DESCRIPTION OF THE DRAWINGS

Exemplary embodiments are described herein with reference to the following drawings.

FIG. 1 illustrates an exemplary public transit vehicle route schedule and notification system.

FIG. 2 illustrates an exemplary client application program execute on a mobile computing device.

FIG. 3 is a flowchart of example techniques for providing the client scheduler and notification on a mobile computing device.

FIG. 4 illustrates an exemplary server application program execute on a route context analytics server.

FIG. 5 is a flowchart of example techniques for providing the server notification on a route context analytics server.

### DETAILED DESCRIPTION

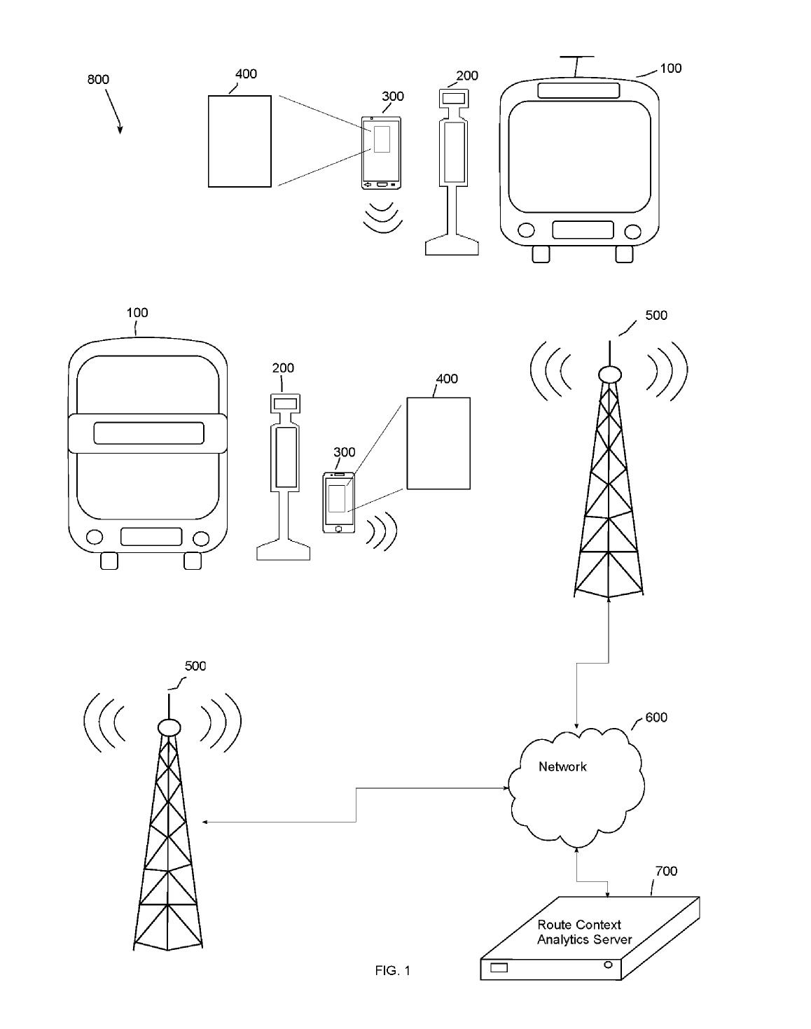

FIG. 1 is the vehicle route schedule and notification system 800 includes a route context analytics server 700, a plurality of mobile computing devices 300, an application program 400 that operates on mobile computing device 300. The route context from multiple mobility computing devices will be aggregated in the route context analytics server 700. The application program 400 comprise instructions which read and executed by mobile computing device 300, cause the mobile computing device 300 to execute the units or steps of the embodiment.

The mobile computing device 300 can be any kind of a variety of mobility device, such as smart phone, 2G, 3G, 4G LTE phone, application phone, personal digital assistant (PDA), tablet computer, notebook computer, mobile phone, cellular phone and any other known or later developed mobile device with cellular network, voice calls, SMS, EMS or MMS messaging and cellular data communication function. The mobile computing device 300 can be configured to input the daily route context and save to memory storage to provide a historical route context record.

A plurality of vehicles 100 may be any kind of public transit vehicles, for example bus, minibus, streetcar, tram, trains, bus rapid transit, trackless trolley, shutter bus, school bus, coach etc. A plurality of vehicle stops 200 maybe any kind of vehicle stops. The vehicle stop may be a vehicle station name, vehicle stop name or vehicle depot. The vehicle stop may also contains route identifier, vehicle stop identifier, route identification number, or any other representation value shown in the code plate placed in the vehicle stop stand.

A passenger holds a mobile computing device 300 standing nearby the vehicle stop 200 waiting for vehicle approaching to a vehicle stop. Passenger that input the route context when vehicle arrived or get on the vehicle stored in an application program 400 helping to keep track and record the vehicle daily arrival or departure time in the same route. The application program 400 can predict the next arrival time and generate the suggested range for passenger plan the schedule go to a pick-up vehicle stop.

The mobile computing device 300 can wireless communicate with base stations 500 (e.g. a cellular network transceiver, a wireless network router etc.) and obtain access to a network 600 (e.g. the Internet network, public switched telephone network (PSTN), a cellular network, a virtual private network, SMS, EMS or MMS messaging etc.). The mobile computing device 300 through the network 600, can be communicated with the route context analytics server 700 (one or more network server computers in remote location), which can be configured to provide real vehicle arrival and departure time, to generate notification and to update route context to the mobile computing device 300.

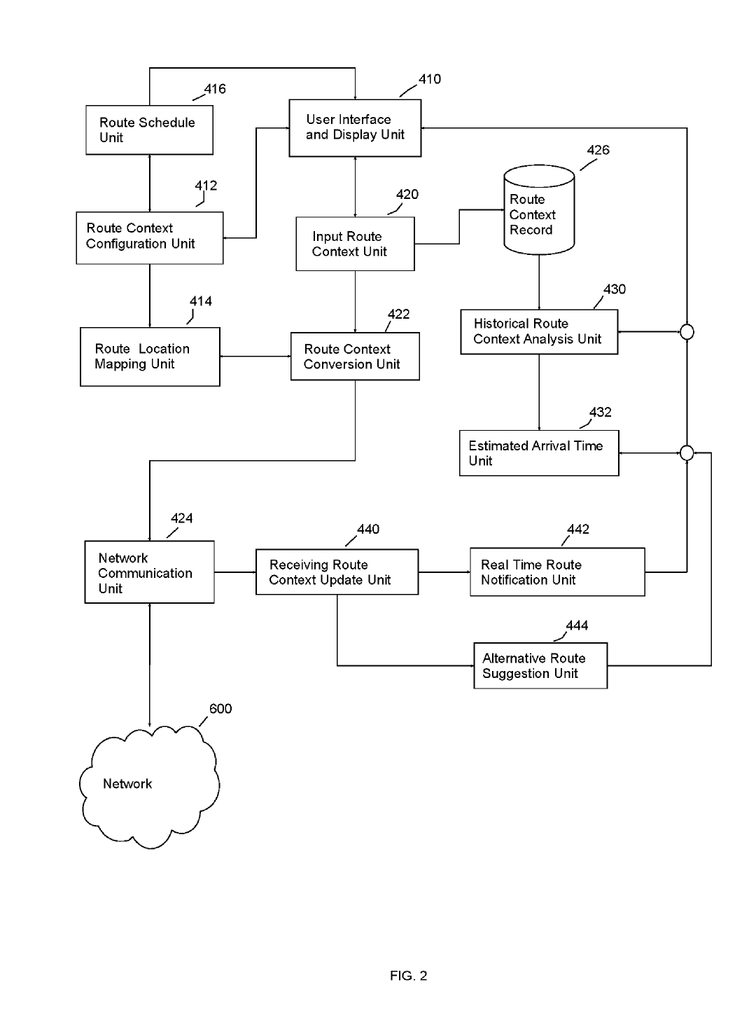

FIG. 2 is illustrates an exemplary client application program 400 which execute on a mobile computing device 300 is depicted as including an user interface and display unit 410, through which mobile computing device 300 can provide the interface for a passenger input current route context by a route context input unit 420, configure route context by a route configuration unit 412, and update the screen. In the user interface and display unit 410 can acquire the route context update from the following units, a historical route context analysis unit 430, an estimated arrival time unit 432, a real time route notification unit 442 and an alternative route suggestion unit 444.

The route context input unit 420 can accept the currently being traveled route context inputted daily by passenger when vehicle at the pick-up vehicle stop, save all daily route context in memory or data storage devices in the mobile computing device 300 as a route context record 426, transfer the daily route context to a route context conversion unit 422. The route context conversion unit 422 can convert the route context into a specific transmission format, e.g. HTML, JSON or XML suitable for Internet network, numeric DTMF suitable for PSTN, plain text suitable for SMS, EMS or MMS messaging communication through a network communication unit 424. The route context at least includes a vehicle arrival time, get on vehicle stop name, vehicle route number or the route final stop name or station name. During communication, the route context may include a schedule alert time range, route configuration, location mapping information, passenger preferences, passenger behavior etc.

The network communication unit 424 can allow passenger selects the communication channel type (e.g. Internet network, cellular network, 2G, 3G, 4G LTE, PSTN network, SMS, EMS or MMS messaging) used to transmit the route context to or receive the route context from the route context analytics server 700, the communication hardware device already a built-in device in the mobile computing device 300. The network communication unit 424 can connect to a receiving route context update unit 440 and connect to the network 600, helping to transmit route context and receive feedback from the route context analytics server 700. The receiving route context update unit 440 can process the received route context from route context analytics server 700, transfer data to a real time route notification unit 442 and an alternative route suggestion unit 444. The real time route notification unit 442 can notify and update the real time route context per each route, real departure time on all vehicle stop before vehicle reach to next vehicle stop, travel time of vehicle on the road. The alternative route suggestion unit 444 can update the other possible route along the near location of pick-up vehicle stop and near location of the target get off vehicle stop.

The route configuration unit 412 which output the configuration to a route location mapping unit 414 and a route schedule unit 416, can allow passenger to configure the habitual route traveled everyday and the route schedule. The route schedule unit 416 can configure the time to be notified a certain amount of estimated time prior to vehicle approach to pick-up location, set the range of the vehicle arrival time to make alert based on the route context record. Passenger is allowed to configure the new notification period at any times. The route location mapping unit 414 which conjunction with the route context conversion unit 422 can determine a geographic location of the vehicle stop with the assist of internal global positioning system (GPS) provided by the mobile computing device 300. The reference geographic location is mapped to the internal route vehicle stop location (e.g. STOP1 location (0, 0) to GPS value 204″20′11.4″N, 211″27′25.2″E.)

A historical route context analysis unit 430 which can request the route context from the route context record 426, can provide the estimated range of arrival time, a statistical report such as maximum, minimum, average arrival time, the schedule to alert passenger go to vehicle stop to wait for vehicle pick-up and the historical route context to review, provide estimated arrival time on the road traffic with the assist of calendar and events information then output to an estimated arrival time unit 432 and direct to the user interface and display unit 410. The estimated arrival time unit 432 can predict the next available time range of the vehicle arrive to the vehicle stop, generate an alert when passenger has set the time to receive notification wait for a vehicle approach to the pick-up vehicle stop.

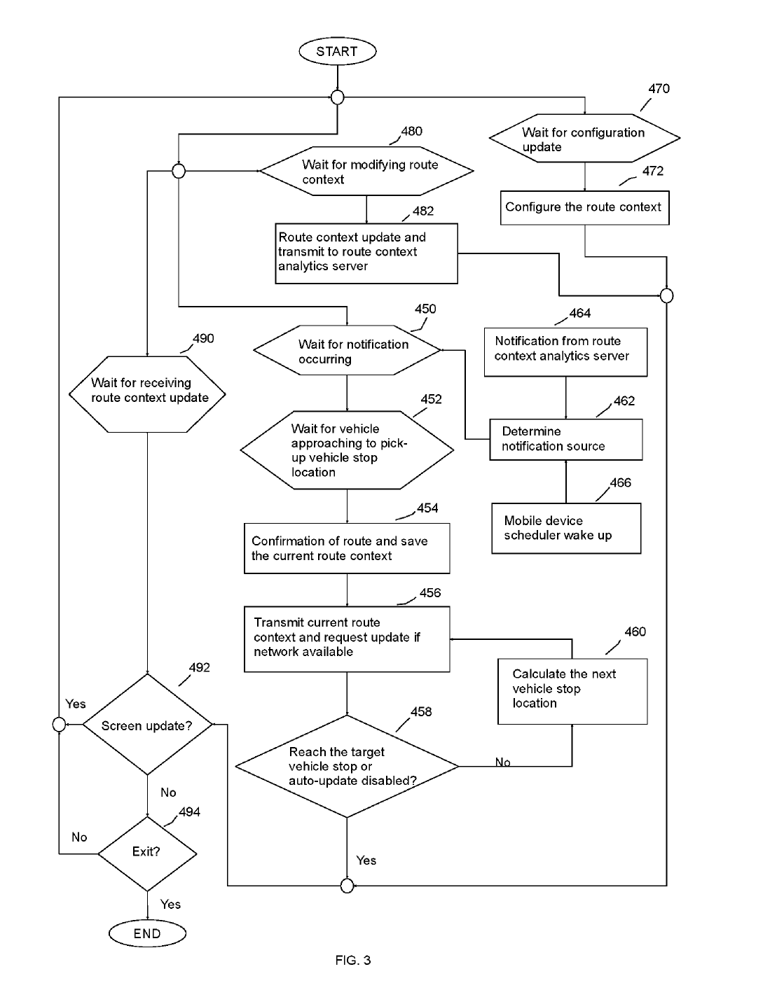

FIG. 3 is a flowchart of example techniques for providing the local route schedule and notification of the application program 400 performing the steps of one of the embodiment. Additional, different or more blocks may be performed in other embodiments.

An application program 400 begins by waiting at four different concurrent process blocks from four kinds of source 450, 470, 480 and 490. A block 450 is wait for notification occur, the source of notification includes receive local timer wake up or remote notification wake up. The next block 462 is a process to determine the notification source output to the block 450. The block 462 received the source in block 464 and block 466. The block 464 can be received arrival notification from remote route context analytics server 700, in the block 466 can be received the local mobile computing device arrival timer wake up due to the schedule time setting.

When a notification occurs in block 450, control passes to blocks 452 to 460 to perform associated operations after passenger take action and go to vehicle stop to wait for vehicle approaching to pick-up stop in block 452, and confirmation of the notification in block 454. The block 454 can accept the notification, confirm and input the current route context. In the case passenger who has rejected the notification, needs to trigger a waiting block 470 to configure new notification time in block 472. After configure new time, passenger wait for new notification occur in block 450.

The next block 456 after block 454 is to detect the network availability, transmit route context to remote server and request update route context. The next decision block 458 after block 456 is to determine the update mechanism. There are two mechanisms to input the current route context, one is automatically update route context, and one is manual update route context. Under auto-update mechanism, need to calculate the next vehicle stop location in process 460 and repeat the process in block 456 to detect the network availability. This mechanism automatically save the current route context in memory and the route context would be transmitted to remote server under network available, stop to operate when reached the target pick-up vehicle stop. Under manual update, passenger input and save the current route context in memory and the route context would be transmitted to remote server under network available. Finish both mechanisms, a process block 458 go to decision block 492.

A passenger is allowed to update the configuration at any times in the waiting block 470, control passes to block 472 to accept the configuration of route context. A passenger can input or update the route context detected in block 480, control passes to block 482 to accept the modification of route context configuration. Any route context input or configuration update or receive route context update from network 600 will go to the decision block 492.

In the block 490, control passes to decision block 492. The block 492 is to update the screen, repeat the process or go to exit decision block 494. The block 494 can make decision to repeat the process to wait for another source trigger or exit the application.

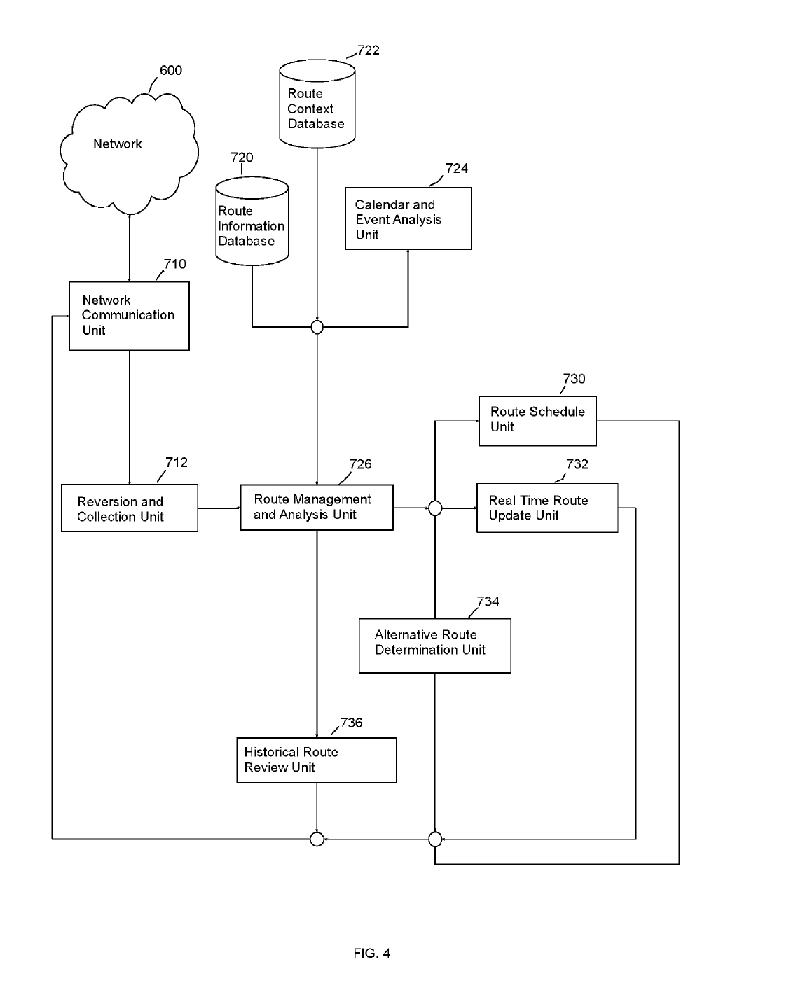

FIG. 4 is illustrates an exemplary server side application program execute on a route context analytics server 700. A network communication unit 710 can connect to the network 600 and a reversion and collection unit 712. The network communication unit 710 can accept all the output from units 730, 732, 734 and 736, transmit the server side route context to passenger. Such server side route context may include an alternative route suggestion, estimated arrival time and real departure time, next available vehicle arrival time, road travel time. The network communication unit 710 includes receive or transmit channel selection to perform receiving route context, to perform transmit route context and select different transmission channel. Received data then transfer to the reversion and collection unit 712, to perform transmit route context and select different transmission channel, such as internet network, PSTN network, SMS, EMS or MMS messaging.

The route context reversion and collection unit 712 can reverse the route context back to original format that server can recognise, collect all the route context with different vehicle route on each route from a plurality of mobile computing device 300. All reversed route context which pass to a route management and analysis unit 726 save to the following database 720 and 722. The route management and analysis unit 726 can generate the notification range of arrival time to a route schedule unit 730, update the route context per each route to a real time route update unit 732, provide and analyse an alternative route suggestion to an alternative route determination unit 734, save and separate all other aggregated route context to single vehicle route to a historical route review unit 736. The historical route review unit 736 can output the collected historical route context by the request from passenger wants to review all the route record.

The route management and analysis unit 726 may use a route information database 720, a route context database 722, the data from a calendar and event analysis unit 724 can manage and analyse a plurality of vehicle routes. The route information database 720 can store the route details such as the timetable, route fares, origin and destination vehicle stop, every vehicle stops on route, route ID, geographic location provided by public transit vehicle company. The route context database 722 can store the collected user behavior, user preference, alert time, notification period and route context received from a plurality of passengers. The calendar and event analysis unit 724 can predict the road traffic delay by analysis the calendar of public holidays, special event on the coming date.

The real time route update unit 732 can update the real time route context per each route to passenger, real departure time on all vehicle stop before vehicle reach to next vehicle stop, travel time of vehicle on the road. All route context of different vehicles on road are collected, the distance and position between same route number but different vehicle on the road can be determined.

The alternative route determination unit 734 can determine the other possible route along the near location of pick-up vehicle stop and near location of the target get off vehicle stop.

The historical route review unit 736 can provide the record of all other aggregated route context per route along the roadway. The route schedule unit 730 can collect notification setting of passenger, generate a notification for individual passenger and make reminder to individual passenger to decide the time range to go to the vehicle stop wait for vehicle arrival.

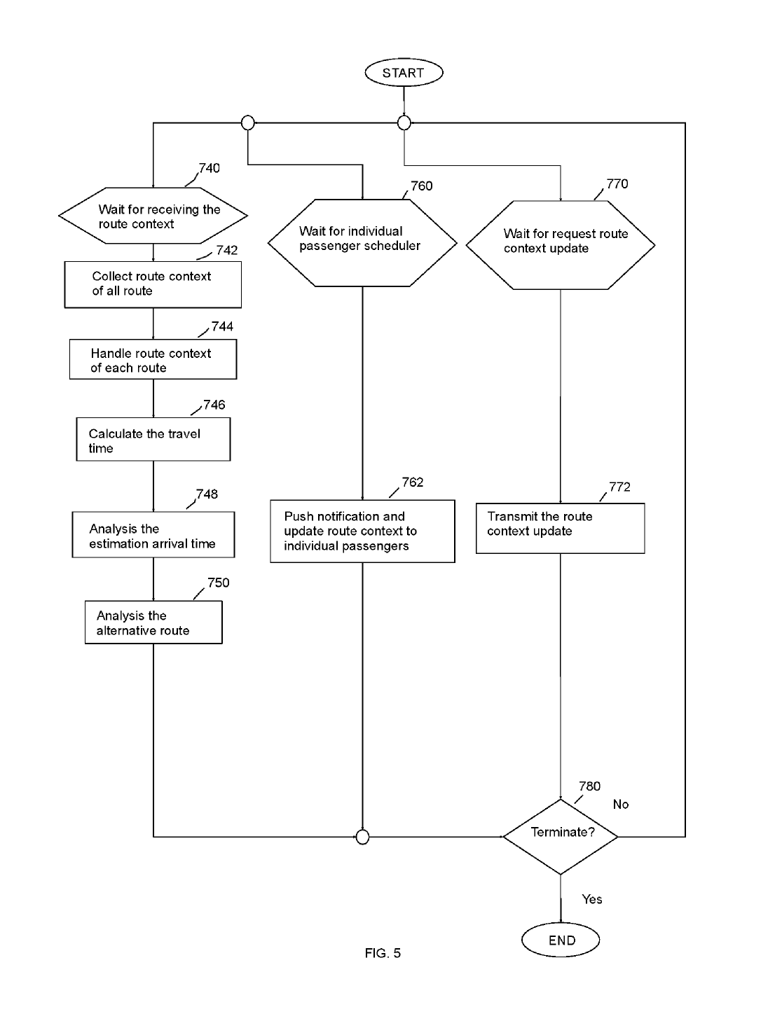

FIG. 5 is a flowchart of example techniques for providing the remote route schedule and notification on the route context analytics server 700. The program begins by waiting from different sources at three blocks 740, 760, 770. The block 740 is wait for receiving the route context from client application 400, the block 760 is wait for the timer wake up that meet the individual passenger notification period, the block 770 is waiting for acquiring route context update by passenger request.

In the block 740, the route context received from a plurality of passengers through the network 600, the server can collect the route context of all routes in a block 742, separate and handle all route context of each route is performed in block 744, a next block 746 calculate the vehicle travel time at the pick-up vehicle stop on every vehicles on the roadway per each route, a block 748 estimate the route arrival time based upon the real departure time of vehicle left the prior vehicle stop, historical route record and other route travel time.

A block 750 is followed a block 748, based on the calculated travel time with same distance on every route, route travel time can be determined; an alternative route is concluded in a block 750.

In a block 760, when meet the schedule alert time of individual passenger, the notification is generated and the updated route context is transmitted to passenger. In a block 770, request is received from different passengers; the update route context is transmitted to individual passenger in block 772.

After finished the steps of blocks 750, 762 and 772, the block 780 determine the termination of the process or repeat the process go to wait states.

The route schedule and notification system includes clients and servers. A client in the embodiment is the mobile computing device and server in the embodiment is the route context analytics server, they are remote from each other and communicate through a network (e.g. the Internet network, public switched telephone network (PSTN), a cellular network, a virtual private network, SMS, EMS or MMS messaging etc.).

A client and server computer-implemented mechanism has been described in above section, other modifications are possible for providing route schedule and notification on a mobile computing device may be used. The process units and logic flows do not require the sequential order depicted in the figures to perform same results. Other units or steps may be added or eliminated from the described figures. Accordingly, other implementations are within the scope of the following claims.

1. A computer-implemented method on the mobile computing device comprising: collecting and saving a route context from a plurality of passengers at a pick-up vehicle stop along a roadway, providing an estimated time of vehicle approaching to a pick-up vehicle stop, providing a historical route context analysis and review, predicting the next available time range of the vehicle arrive to the vehicle stop, generating a notification for passenger to remind them plan the schedule to wait for vehicle arrival, transmitting the route context to a route context analytics server to perform a real time route analysis and provide an alternative route suggestion.

2. The computer-implemented method of claim 1, wherein the route context may be represented by a numeric or alphanumeric value may include a vehicle arrival time, get on vehicle stop name, vehicle route number or the route final stop name or station name, vehicle driver name, vehicle driver identification number, vehicle route identifier, vehicle license plate number, passenger waiting time at vehicle stop, every arrival time at different vehicle stop, get off vehicle time; may extra includes a schedule alert time range, route configuration, location mapping information, passenger preferences, passenger behavior.

3. The computer-implemented method of claim 1, wherein a route context input includes accept a route context inputted daily by passenger when vehicle arrived at the pick-up vehicle stop, save all daily route context as a route context record in memory or data storage devices in the mobile computing device.

4. The computer-implemented method of claim 1, wherein a route context configuration includes configure the habitual route traveled everyday and route schedule.

5. The computer-implemented method of claim 1, wherein a historical route context analysis includes provide the estimated range of arrival time, a statistical report such as maximum, minimum, average arrival time, the schedule to alert passenger go to vehicle stop to wait for vehicle pick-up and the historical route context to review.

6. The computer-implemented method of claim 1, wherein an estimated arrival time includes predict the next available time range of the vehicle arrive to the vehicle stop, generate an alert when passenger has set the time to receive notification for wait for a vehicle approach to the pick-up vehicle stop.

7. The computer-implemented method of claim 1, wherein a route schedule includes configure the time to be notified a certain amount of estimated time prior to vehicle approach to pick-up location, set the range of the vehicle arrival time to make alert based on the route context record.

8. The computer-implemented method of claim 1, wherein a route context conversion includes convert the route context into a specific transmission format, e.g. HTML, JSON or XML suitable for Internet network, numeric DTMF suitable for PSTN, plain text suitable for SMS, EMS or MMS messaging communication.

9. The computer-implemented method of claim 1, wherein a network communication includes select the communication channel type (e.g. Internet network, cellular network, 2G, 3G, 4G LTE, PSTN network, SMS, EMS or MMS messaging) used to transmit or receive the route context.

10. The computer-implemented method of claim 1, wherein a real time notification includes notify and update the real time route context per each route, real departure time on all vehicle stop before vehicle reach to next vehicle stop, travel time of vehicle on the road.

11. The computer-implemented method of claim 1, wherein an alternative route suggestion includes the other possible route along the near location of pick-up vehicle stop and near location of the target get off vehicle stop.

12. A computer-implemented method on the route context analytics server comprising:
receiving a route context from a plurality of mobile computing devices along a roadway, analysing, predicting or estimating the time of vehicle approaching to the vehicle stop, providing real vehicle departure time, calculating the travel time of vehicle on the road, determining an alternative vehicle route to reach the destination, generating the real time route notification for passenger to plan the schedule to wait for a vehicle arrival.

13. The computer-implemented method of claim 12, wherein the route context may be represented by a numeric or alphanumeric value may include an alternative route suggestion, estimated arrival time, real departure time, next available vehicle arrival time, travel time of vehicle on the road.

14. The computer-implemented method of claim 12, wherein a network communication includes receive or transmit channel selection to perform receiving route context, to perform transmit route context and select different transmission channel.

15. The computer-implemented method of claim 12, wherein a route context reversion and collection includes reverse the route context back to original format that server can recognise, collect all route context with different vehicle route on each route.

16. The computer-implemented method of claim 12, wherein a route management and analysis includes generate the notification range of arrival time, update the route context per each route, provide and analyse an alternative route suggestion, save and separate all other aggregated route context to single vehicle route.

17. The computer-implemented method of claim 12, wherein a real time route update includes update the real time route context per each route, include real departure time on all vehicle stop before vehicle reach to next vehicle stop, travel time of vehicle on the road.

18. The computer-implemented method of claim 12, wherein an alternative route determination includes determine the other possible route along the near location of pick-up vehicle stop and near location of the target get off vehicle stop.

19. The computer-implemented method of claim 12, wherein a route schedule includes collect notification setting of passenger, generate a notification for individual passenger, make reminder to individual passenger to decide the time range to go to the vehicle stop wait for vehicle arrival.

20. The computer-implemented method of claim 12, wherein a historical route review includes provide the record of all other aggregated route context per route along the roadway.
